(19) United States
(12) Patent Application Publication
(10) Pub. No.: US 2008/0132235 A1
(43) Pub. Date: Jun. 5, 2008

(54) Method to Facilitate Pre-Provisioning a Wireless Access Point With a One-Time Password to Facilitate Authorized Handoffs for a Given Communication Session

(75) Inventors: Paul R. Hancock, Barrington, IL (US); Charles D. Gavrilovich, Park Ridge, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/757,105

(22) Filed: Jun. 1, 2007

Related U.S. Application Data
(63) Continuation-in-part of application No. 11/564,950, filed on Nov. 30, 2006.

(51) Int. Cl. H04Q 7/20

(52) U.S. Cl. 455/436

(57) ABSTRACT

A server automatically determines a path by which a mobile device will likely move to a particular geographic destination and service times during which this particular mobile device will likely receive service with respect to this communication session at various ones of a plurality of wireless access points. This server can then provide a plurality of one-time passwords and use this path and service time information to dynamically schedule support (by at least some of the plurality of wireless access points) for that given communication session. Moreover, pursuant to these teachings, this server can pre-provision at least one of the one-time passwords to a given one of the wireless access points prior to an anticipated handoff to thereby facilitate rapid authentication of that mobile device with respect to later effecting the handoff, wherein the one-time password has a corresponding effective time interval associated therewith.

### RELATED APPLICATIONS

This application comprises a continuation-in-part of METHOD AND APPARATUS TO FACILITATE USING A PATH TO DYNAMICALLY SCHEDULE WIRELESS ACCESS POINT SUPPORT FOR A GIVEN COMMUNICATION SESSION as filed on Nov. 30, 2006 and having application Ser. No. 11/564,950 (CML03779NET), the contents of which are fully incorporated herein by this reference.

### TECHNICAL FIELD

This invention relates generally to wireless communications and more particularly to wireless communications handoffs.

### BACKGROUND

Wireless communications systems of various kinds are known in the art and new approaches are often being developed as well. In many cases a given user interfaces with the system via a wireless access point. The wireless access point, in turn, often couples directly or indirectly to other access points and/or one or more networks to permit one-way or two-way communications between the user and one or more other parties or entities.

Many such systems will accommodate a mobile user. More particularly, many systems will permit an on-going communication session to be switched (or handed-off) without substantial interruption from one access point to another as the mobile user moves in and out of the service areas for such access points. In many cases existing approaches in this regard serve adequately enough. In a growing number of instances, however, existing approaches in this regard present a sub-optimal experience.

As one illustrative example in this regard, in many application settings it may be useful or even necessary to ensure that a given mobile device is authorized to be the recipient of such a handoff. For example, in some cases, such a user platform may have had the appropriate authorization to have begun a given communication session with a particular wireless access point, but this authorization may not legitimately extend beyond this particular wireless access point. As a result, it can therefore be necessary to conduct an authorization activity for each such handoff. Unfortunately, such authorization activities can require considerable time. In some cases, this can lead to delays during which the mobile device may be without service. At a minimum this can cause disruptions in the communication session and can even lead, in egregious instances, to the dropping of that communication session. Such experiences, of course, are discouraging to the user as well as the system operator.

### BRIEF DESCRIPTION OF THE DRAWINGS

The above needs are at least partially met through provision of the method to facilitate pre-provisioning a wireless access point with a one-time password to facilitate authorized handoffs for a given communication session described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a block diagram as configured in accordance with various embodiments of the invention;

FIG. 4 comprises a flow diagram as configured in accordance with various embodiments of the invention;

FIG. 5 comprises a flow diagram as configured in accordance with various embodiments of the invention;

FIG. 6 comprises a block diagram as configured in accordance with various embodiments of the invention;

FIG. 7 comprises a lookup table as configured in accordance with various embodiments of the invention; and

FIG. 8 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a server that is participating in a communication session with a particular mobile device can determine that this particular mobile device has present and future needs for a given amount of bandwidth in service of a given communication session while moving with respect to a plurality of wireless access points to a particular geographic destination. Upon then automatically determining a path by which this mobile device will likely move to that particular geographic destination and service times during which this particular mobile device will likely receive service with respect to this communication session at various ones of the plurality of wireless access points, this server can provide a plurality of one-time passwords and then use this path and service time information to dynamically schedule support (by at least some of the plurality of wireless access points) for that given communication session while also providing at least the given amount of bandwidth. Moreover, pursuant to these teachings, this server can pre-provision at least one of the plurality of one-time passwords to a given one of the wireless access points prior to an anticipated handoff to thereby facilitate rapid authentication of that mobile device with respect to later effecting the handoff, wherein the one-time password has a corresponding effective time interval associated therewith.

So configured, this given communication session can remain fully and substantially continuously serviced by various ones of the plurality of wireless access points with at least the given amount of bandwidth as the particular mobile device moves to the particular geographic destination. In particular, the aforementioned one-time passwords can serve to vouch for the authorized status of the mobile device to make the corresponding handoff.

By one approach, such service times can be so determined by automatically determining approximate arrival times with which a handoff of the communication session can be coordinated. If desired, a given wireless access point can be so pre-provisioned with a plurality of one-time passwords. In such a case, for example, one of the one-time passwords can be associated with a first arrival time and have handoff time interval of a specific duration. A second such one-time password can then be associated with a second arrival time that comprises the first arrival time plus the aforementioned (or a different) handoff time interval. So configured, and presuming that relevant components with the network are substantially synchronized with respect to time, the mobile device can present a specific one-time password to a wireless access point as corresponds to a present time of day and the latter can determine the correctness of that proffered one-time password again as a function of the present time of day.

These teachings will also readily accommodate, if desired, detecting when such a mobile device has at least substantially deviated from the aforementioned path and then automatically determining a new path and/or new service times by which the mobile device will now likely move to the geographic destination. The server can then use this new information to dynamically re-schedule use of the aforementioned one-time passwords and/or to conduct further pre-provisioning activities as appropriate.

So configured, these teachings can greatly ameliorate or even obviate the kinds of quality-of-service degradations that have characterized the prior art in such application settings. Those skilled in the art will recognize and appreciate that these teachings comprise a highly flexible and economical approach that will accommodate use with a wide variety of communication system architectures, protocols, and the like. It will further be appreciated that these teachings are highly scalable and can be well employed with any number of access points, mobile devices, and so forth. It will further be understood and appreciated that the relative security offered by such an approach is relatively high as the period of usability for any given one-time password is no longer than the handoff time interval as is associated therewith. By making that interval relatively brief, little opportunity exists for misuse of such information even if intercepted by unauthorized parties.

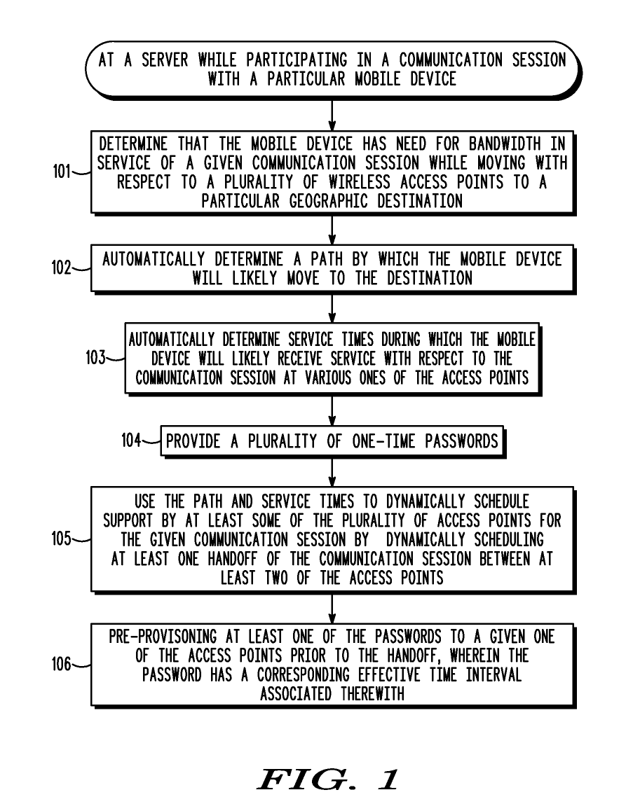

These and other benefits may become clearer upon making a thorough review and study of the following detailed description. Referring now to the drawings, and in particular to FIG. 1, an illustrative process 100 that can be employed by a server, while that server is participating in a communication session with a particular mobile device, provides for determining 101 that this particular mobile device has present and future needs for a given amount of bandwidth in service of a given communication session while moving with respect to a plurality of wireless access points to a particular geographic destination. There are various ways by which such a determination can be accomplished. Depending upon the needs and/or opportunities associated with a given application setting, by one approach, this can comprise, at least in part, receiving a message from the particular mobile device via the communication session with the server regarding, at least in part, the given amount of bandwidth, a present location of the particular mobile device, and the particular geographic destination.

Other information could also be provided via such a message if desired. Such other information could include, if desired, information regarding a scheduled or estimated amount of time that the mobile device will require the indicated amount of bandwidth, a scheduled and/or estimated time of arrival at the particular geographic destination, and so forth.

In the example provided above, the server receives this message from the mobile device. By one approach this can comprise a direct communication as suggested by the example provided. This process 100 will also accommodate, however, receiving such information more indirectly. For example, a media server and/or a presence server may keep the server apprised of such information. By this approach, the services described below as rendered by this server could be offered in a more transparent manner to the mobile device.

It would also be possible for this server to make the described determination upon referring to schedule information as may be available, for example, in an available profile for the mobile device. Such a profile might reveal, for example, that a given user leaves a first location (such as their home) every weekday at approximately 7 AM and travels to a given destination (such as their office) with an intent to arrive by about 8 AM.

This process 100 then provides for having the server automatically determine 102 a path by which the particular mobile device will likely move to the particular geographic destination. This can comprise, for example, receiving the path information from the particular mobile device (as may be available when the mobile device has (or itself comprises) a navigational aid that includes route planning functionality). In such a case, the corresponding route information can be provided to the server along with, or as a supplement to, the previously mentioned message(s).

By another approach, the automatic determination 102 can comprise having the server predict a path by which the particular mobile device will likely move to the particular geographic destination. In this case, the server can make its own prediction or can, if desired, access a route planning resource (such as a route planning server) to receive the predicted path information.

If desired, such a prediction can be based upon more than simply the start and end points of the route. For example, it would also be possible to further inform such route predicting with profile information that may be available regarding the user/mobile device. Such a profile, for example, might reveal that this user has a preference for (or aversion to) Interstate highways when available, unless those highways are toll-bearing, in which case the user prefers alternative routes. As another example, such a profile might indicate that this user greatly prefers routes that avoid the use of left turns. As yet another example, a given user's profile might stipulate that the user prefers a shortest distance route or that the user prefers a route that will offer the shortest travel time. When available, such information can be used to better predict the particular route by which the mobile device will likely traverse the distance to its intended destination.

If desired, when the server itself determines the route by which the mobile device will likely travel, the server can communicate that route information to the mobile device as either a recommended path and/or as a point of confirmation. By informing the mobile device of the recommended path, the mobile device can then move to the particular geographic destination using that recommended path. By this approach, the server can effectively serve as a navigation aid for the mobile device while also potentially increasing the effective accuracy of the prediction regarding the likelihood of the mobile device actually following this particular predicted route.

This process 100 also automatically determines 103 service times during which the particular mobile device will likely receive service with respect to the communication session at various ones of the plurality of wireless access points. Such a determination can be based, for example, upon the aforementioned path information along with information such as a present or projected velocity of the mobile device itself that tends to directly or indirectly provide a basis for estimating when the mobile device will be at various points along the projected path. This determination can also take into account, if desired, information regarding the effective coverage areas for the various wireless access points (including information regarding bandwidth availability, terms and conditions of usage, areas of coverage overlap, present and projected loading, and so forth).

So configured, for example, this step could comprise determining that the particular mobile device will likely receive service for the communication session at a first wireless access point beginning at time X, followed by receiving service at a second wireless access point beginning at time Y (which might be, for example, two minutes later than X). By one approach, then, these determined service times can comprise, at least in part, approximate (or even exact, when possible) arrival times with which a handoff of the communication session can be coordinated.

By one approach, this step can comprise automatically determining a plurality of approximate predicted arrival times as correspond to when the communication session can be handed off to a given one of the wireless access points. As one illustrative example in this regard, this can comprise determining a first predicted arrival time of 3:00 PM, a second predicted arrival time of 3:00:30 PM, and a third arrival time of 3:01 PM. By this approach, for example, each such arrival time can have a corresponding handoff time interval associated therewith, such that an arrival of the particular mobile device within a given handoff time interval equates with arriving at the corresponding predicted arrival time. In such a case, and to continue with the simple illustrative example, a mobile device arriving at 3:00:45 PM will have arrived during the handoff time interval as corresponds to the 3:00:30 PM arrival time. The use of such a determination will be discussed further below.

In such a case, if desired, each of these handoff time intervals can be substantially identical for each of the predicted arrival times. In the above illustrative example, for example, the handoff time interval is 30 seconds for each arrival time. These teachings will readily accommodate greater flexibility in this regard if desired, however. For example, if desired, each predicted arrival time of a plurality of predicted arrival times can have a different corresponding handoff time interval. The particular approach selected for use by a corresponding system administrator can vary, for example, with respect to the particular characterizing aspects of a given application setting.

This process 100 then provides 104 a plurality of one-time passwords. These are passwords that will serve, as described below, to authenticate that a given mobile device is authorized to be the beneficiary of a handoff of a communication session to a particular wireless access point. This can of course entail accommodation of whatever accounting, authorization, and authentication process or processes may be relevant in a given application setting for a given mobile device and/or wireless access point. Various approaches are known in the art in this regard. As these teachings are not overly sensitive to any particular selection in this regard, for the sake of brevity and the preservation of clarity, further elaboration in this regard will not be presented here.

By “one-time,” it will be understood that these passwords are intended to correspond to a one-time opportunity for usage as a pre-authorization mechanism for a communication session. This does not require, however, that these passwords be utterly unique for all time and for all purposes as some re-use of a given password, with respect to time and/or place of usage, can certainly be tolerated without conflicting with these intended purposes.

As will be described below in more detail, each of these one-time passwords can be associated with a given one of the above-mentioned service times. By one approach, this can comprise associating such passwords with corresponding arrival times. As a very simple illustration, a first password could be associated with arrival time X and a second, different password could be associated with arrival time X+T1 (where, for example, “X” can comprise a time of day and “T1” can comprise an interval of time).

As noted, such one-time passwords are intended to facilitate timely handoffs by serving, at least in part, to represent the authorized status of the corresponding mobile device to in fact be serviced in this manner. By one approach, one or more of these one-time passwords can be intended for use by a wireless access point to authenticate the particular mobile device. By another approach, in combination with the foregoing or in lieu thereof, one or more of these one-time passwords can be intended for use by the particular mobile device to authenticate the wireless access point. The particular approach chosen in this regard in a given application setting will of course vary with the needs, requirements, and/or opportunities as tend to characterize that application setting. As one illustrative example in this regard, this could comprise providing a first different one-time password for each of a plurality of approximate arrival times for use by a wireless access point to authenticate a particular mobile device and providing a second different one-time password for each of the plurality of approximate predicted arrival times for use by the particular mobile device to authenticate the wireless access point. Other approaches and variations are of course possible.

This process 100 then provides for having the server use the path and the service times to dynamically schedule support 105, by at least some of the aforementioned plurality of wireless access points, for the given communication session while providing at least the given amount of bandwidth required by the mobile device for that session. This can comprise, in particular, dynamically scheduling at least one handoff of the given communication session between at least two of the plurality of wireless access points for the given communication session while providing at least the given amount of bandwidth.

This can be based, at least in part, upon a priori knowledge regarding the existence, location, and relative service areas of the wireless access points. Such information can be already available (via, for example, look-up tables or other data retention mechanisms) and/or can be dynamically developed by querying and/or probing such wireless access points regarding such characterizing information. Other information of potential benefit might comprise, but is not limited to, information regarding supported frequency bands, modulation types, encryption, protocols, identifiers, and so forth.

As will be shown below, this can comprise scheduling various ones of the wireless access points to provide such support at the mobile device moves in, and out, of their respective service areas. By one approach, this can comprise scheduling such support within a particular window of time (based upon a calculated time by when the mobile device will reach specific locations along the predicted path). For example, a first wireless access point can be scheduled to provide a given level of support from around time T1 to time T2 while a second wireless access point is scheduled to provide that same level of support from around time T2 to time T3, and so forth. Such scheduling helps to avoid unduly over-scheduling a given wireless access point as might occur by simply reserving service at all wireless access points along the path for the entire duration of the journey. This, in turn, permits a higher overall level of genuine usage of wireless access point resources and improves overall bandwidth usage and throughput for all users.

By one approach, such scheduling can occur completely transparently to the mobile device itself. That is, the support of the mobile device may be automatically switched from wireless access point to wireless access point with the mobile device playing a relatively passive role. By another approach, such scheduling can include a more active role for the mobile device. This might include, for example, transmitting scheduling information to the mobile device (such as information regarding scheduled support times, wireless access point information, and so forth) to permit the mobile device to use such information in a more proactive manner during the course of the journey.

Such attempts at scheduling, of course, may reveal that given wireless access points are unable to provide the necessary level of support at the requested times. This might occur because the wireless access point is simply without that level of bandwidth capability as a native capability. This might also occur, for example, because the wireless access point has a scheduling conflict that leaves that wireless access point with diminished capability during at least part of the requested window of support time.

In such a case, if desired, the wireless access point can respond to the server with information regarding this inability to provide the requested support along with information regarding what level of support could be provided at the times requested. Upon determining that this wireless access point is unable to provide the given amount of bandwidth as requested, the server can then take appropriate responsive actions. This could comprise, for example, using an alternative wireless access point (or points) that can provide the necessary level of service along the predicted path as a substitute for the unavailable service of this particular wireless access point. This could also comprise, if desired, scheduling parallel support by two or more such wireless access points in order to provide, in the aggregate, the required amount of bandwidth.

Those skilled in the art will recognize and appreciate that these scheduling actions are taken prior to the immediate need for the corresponding services. This, in turn, provides time to permit such alternatives to be explored when bandwidth deployment options are unavailable as requested without causing an interruption to the real-time flow of data being experienced by the mobile device. As a result, such an approach goes far to facilitate a highly transparent process that preserves the perception and reality of a single continuous uninterrupted experience for the user of the mobile device as they move from their original location to their intended target destination.

As noted above, the scheduled support may well include one or more handoffs from one wireless access point to another. To further facilitate the timely handling of such handoffs, this process 100 will further provide for pre-provisioning 106 at least one of the aforementioned plurality of one-time passwords to a given one of the at least two wireless access points are scheduled to support such a handoff to thereby facilitate rapid authentication of the particular mobile device with respect to later effecting that handoff. This step can also comprise, as desired, providing one or more such passwords to a given mobile device to aid with such handoffs (where such passwords might be identical to those provided to one or more of the wireless access points and where a given one of the passwords is to be presented by the mobile device to the wireless access point to thereby vouch for the pre-authorized status of the mobile device and/or the opposite (for example, where the wireless access point must also authenticate itself with the mobile device)).

So configured, the given communication session will tend to remain fully and substantially continuously serviced by various ones of the plurality of wireless access points with at least the given amount of bandwidth as the particular mobile device moves to the particular geographic destination.

It is of course possible that a given mobile device will deviate, and perhaps substantially, from the predicted path. It is also possible that the rate by which the mobile device traverses the path can vary from that which has been earlier predicted. This can occur for any number of reasons including, but not limited to, dynamically changing travel circumstances (reflecting, for example, traffic accidents, unknown obstacles, construction work, and the whims of the driver, to note but a few), an incorrect initial prediction, and so forth. It is also possible for such path and/or temporal deviations to render the aforementioned scheduling unsuitable. The actual path and/or rate of traversal used by the mobile device may be inconsistent with the service scheduling plans such that, unless changed, the mobile device may become without complete (or any) support for the given communication session.

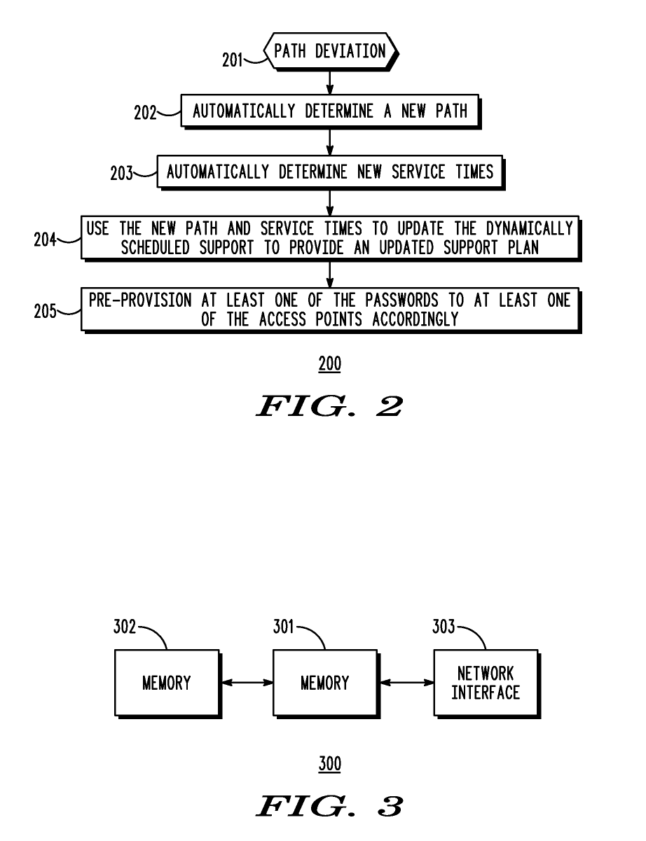

Accordingly, if desired and referring now to FIG. 2, an optional process 200 can comprise, upon detecting 201 that the mobile device has at least substantially deviated from the predicted path, automatically determining 202 a new path by which the particular mobile device will likely move to the particular geographic destination and/or automatically determining 203 new service times during which the particular mobile device will likely receive service with respect to the communication session at various ones of the plurality of wireless access points. There are various direct and indirect ways by which such deviations can be detected. By one approach, the server can receive regular (and/or irregular) updates with respect to the actual location of the mobile device (as may be based, for example, upon global positioning system calculations developed by the mobile device or that are available to the mobile device). There are other known approaches as well by which the location of the mobile device can be ascertained and then communicated to the server for these purposes. As these teachings are not overly sensitive to the selection of any particular approach in this regard, for the sake of brevity and the preservation of focus and clarity further elaboration in this regard will not be provided here.

The server can then use the new path to dynamically schedule support for the given communication session while again providing at least the given amount of needed bandwidth. This can again involve interfacing with various ones of the wireless access points to determine their relative temporal and substantive availability and to schedule their particular participatory roles accordingly. In some cases, this may involve rescheduling in some manner an already-scheduled wireless access point. In other cases it may involve scheduling new wireless access points and/or completely unscheduling previously scheduled wireless access points.

Such rescheduling can occur as often as desired. In some cases the frequency by which the server considers or effects such rescheduling can comprise a fixed operating parameter (as when, for example, such a consideration arises every 30 seconds, every one minute, or the like). By another approach, the regularity by which the server makes this consideration can vary with respect, for example, to the application setting. As one illustration in this regard, when a relatively large number of wireless access points having broadly overlapping relatively large service areas are available, it may not be necessary to make such a determination on any particularly frequent basis.

Essentially as described above, this process 200 can then pre-provision 205 at least one of the plurality of one-time passwords to at least one of the wireless access points to thereby facilitate, again, rapid authentication of this particular mobile device with respect to later effecting a handoff in accordance with the updated support plan.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 3, an illustrative approach to such a platform will now be provided.

In this illustrative example the aforementioned server 300 comprises a processor 301 that operably couples to a memory 302 and a network interface 303. The memory 302 can serve to store, for example, part or all of the aforementioned path and service time information, the one-time passwords, and the like. The network interface 303 in turn can comprise a means by which the server 300 communicates to receive and provide the above-described content. The processor 301 itself can be configured and arranged to carry out one or more of the various steps and processes that are presented herein. By one approach, for example, such configuration can comprise programming the processor 301 to act in this manner.

Those skilled in the art will recognize and understand that such an apparatus 300 may be comprised of a plurality of physically distinct elements as is suggested by the illustration shown in FIG. 3. It is also possible, however, to view this illustration as comprising a logical view, in which case one or more of these elements can be enabled and realized via a shared platform. It will also be understood that such a shared platform may comprise a wholly or at least partially programmable platform as are known in the art.

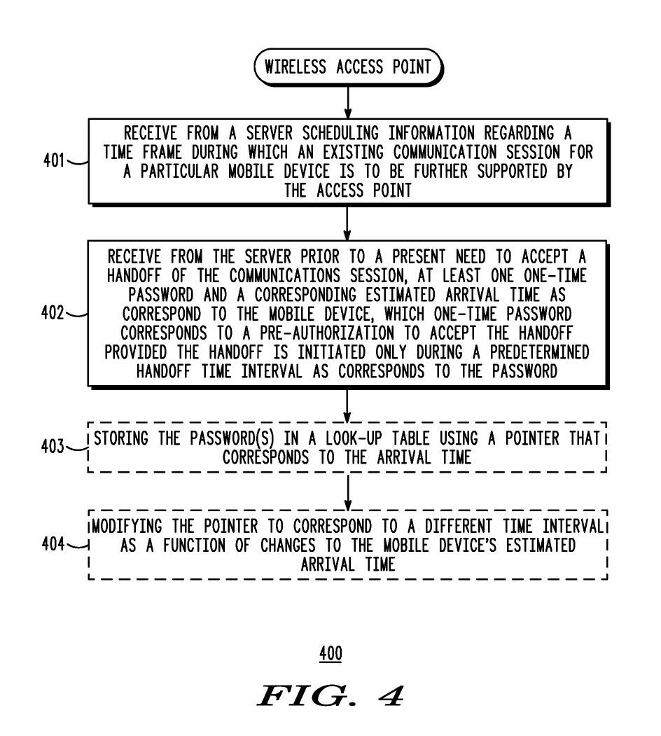

Referring now to FIG. 4, a corresponding illustrative process 400 for the aforementioned wireless access point(s) provides for receiving 401 from a server (such as that described above) scheduling information regarding a time frame during which an existing communication session for a particular mobile device is to be further supported by this wireless access point with at least a minimal level of predetermined bandwidth support as noted above. This process 400 then also provides for receiving 402, from this or another server and prior to an actual present need to accept a handoff of the communication session for this particular mobile device, at least one one-time password as described above along with a corresponding estimated arrival time as correspond to that particular mobile device. As described above, this one-time password corresponds to a pre-authorization to accept the handoff of the communication session for the particular mobile device provided the handoff is initiated only during a predetermined handoff time interval as also corresponds to that one-time password.

By one approach, and also as suggested above, this one-time password can comprise a password that the particular mobile device is expected to present in conjunction with the corresponding arrival time in order to receive the benefit of such pre-authorization. In such a case, the wireless access point could then use its own copy of this one-time password to compare with the password as proffered by the mobile device to determine whether the two match and hence whether the mobile device is to be accorded the corresponding authorization.

By another approach, in conjunction with the approach just described or in lieu thereof, this one-time password can comprise a password that the wireless access point is expected to present to the particular mobile device in conjunction with facilitating the handoff. This approach might be useful, for example, when the communication session comprises a secure or otherwise sensitive communication and the mobile device wishes to confirm the authorized status of the wireless access point to receive the handoff of that communication session.

If desired, this process 400 can also optionally provide for storing 403 this (or these) password(s) in a lookup table using a corresponding pointer(s) that correlates to the corresponding arrival time to thereby render the one-time password(s) quickly available at such time as the one-time password may be required to facilitate the handoff (either to present to the opposite entity and/or to use when confirming and verifying a password as has been received from the opposite entity). As noted above, the projected path and/or arrival times of the mobile device can vary from the original plan and, in such a case, the plan/schedule can be updated accordingly. By this approach, for example, new access points can be similarly provided with a set of one-time passwords as described above. By one approach in this regard, the one-time passwords as provided to a new access point can correspond to one-time passwords (and their corresponding times) as have already been pre-provisioned to the mobile device, thereby avoiding replenishing the mobile device with a new set of one-time passwords.

Also in such a case, and again optionally, the described wireless access point process 400 can modify 404 the aforementioned pointer(s) as a function of such changes to the wireless mobile device estimated arrival time. By this approach, the one-time passwords themselves do not change but the pointers to them can change as a function of the arrival time. In this way the server sends to the mobile device and the access point just the adjusted arrival time. The mobile device and the access points then use the adjusted arrival time to recompute the pointers to the prestored passwords. So configured, the association between the mobile device's one time passwords and the access point's one-time passwords will remain unchanged.

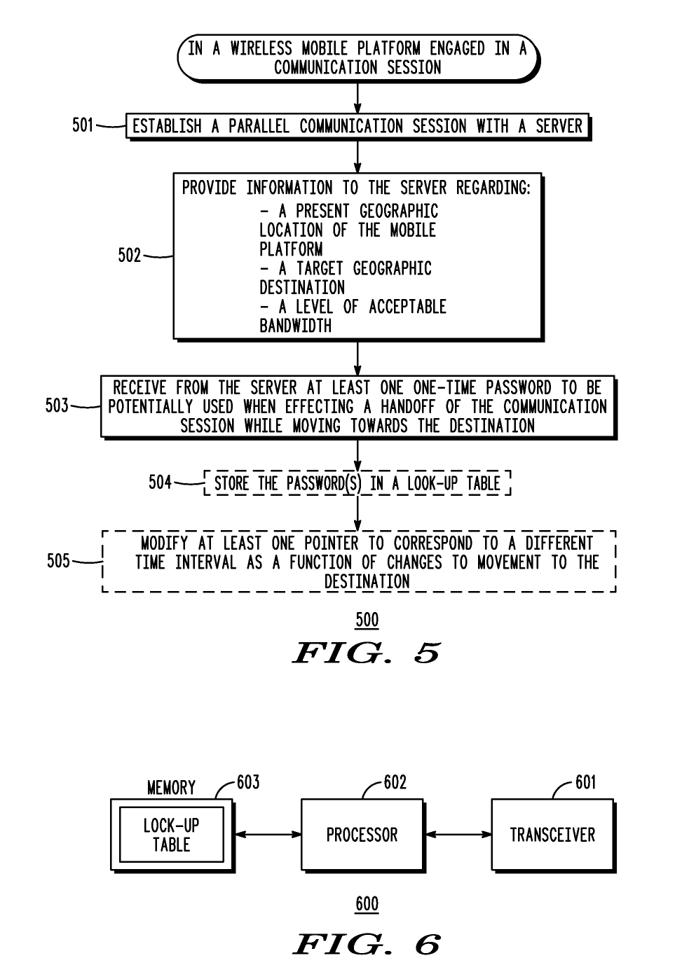

Referring now to FIG. 5, a corresponding illustrative process 500 for the aforementioned mobile platform that is engaged in the ongoing present communication session can provide for establishing 501 a parallel communication session with the aforementioned server in order to facilitate providing 502 information to the server regarding, at least in part, the present geographic location of the wireless mobile platform, a target geographic destination, and a level of acceptable bandwidth to be used when continuing to support the ongoing present communication session as the wireless mobile platform moves to the target geographic destination.

As noted above, this information can further comprise, if desired, information regarding the route that the wireless mobile platform will likely, or intends, to use when moving to the target geographic destination. Also as noted above, this step of providing information to the server can further comprise both the initial provision of such information as well as location updates as the wireless mobile platform moves to the target geographic destination.

As described above, by one approach the server may provide a recommended path to the wireless mobile platform. To accommodate such an approach, if desired, this process 500 can optionally provide for receiving, via the aforementioned parallel communication session, information from the server regarding this recommend path by which the wireless mobile platform can move to the target geographic destination. This process 500 can also accommodate receiving information from the server regarding the scheduled use of a variety of wireless access points during the course of the journey to the target geographic destination. This can include, where desired and appropriate, receiving instructions regarding scheduled parallel use of a plurality of wireless access points to support the communication session in a manner that provides the level of acceptable bandwidth (when, for example, two or more wireless access points are providing, in the aggregate, the required level of bandwidth services at a particular point in time).

This process 500 then also provides for receiving 503 from the server (via, for example, the aforementioned parallel communication session) at least one one-time password to be potentially eventually used when effecting a handoff of the communication session to a corresponding wireless access point while moving towards the target geographic destination. This, of course, will facilitate pre-authenticating the wireless mobile platform with respect to effectuating the handoff. As noted above, such a server may provide a plurality of such one-time passwords (each having a corresponding arrival time and a corresponding handoff interval duration) and in such a case, this step can of course readily accommodate receiving such a plurality of such passwords.

As with the aforementioned wireless access point, if desired, this process 500 will further optionally accommodate storing 504 the received password(s) in a lookup table (which may comprise, in a given application setting, one or more related lookup tables) to thereby render the one-time password(s) quickly available at such time as they may be needed to facilitate a handoff. And again, if desired, this can comprise using a pointer with each such stored password, which pointer corresponds to a corresponding arrival time. When using such a pointer, this process 500 will also optionally accommodate modifying 505 that pointer (or pointers) as a function of changes to the wireless mobile platform's movement to the target geographic destination as is otherwise described herein.

Those skilled in the art will appreciate that the above-described mobile device processes are readily enabled using any of a wide variety of available and/or readily configured platforms, including partially or wholly programmable platforms as are known in the art or dedicated purpose platforms as may be desired for some applications. Referring now to FIG. 6, an illustrative approach to a mobile device will now be provided.

In this illustrative example, a mobile device 600 can comprise a wireless transceiver 601 (by which the mobile device 600 can engage in the described communication sessions) that operably couples to a processor 602. The processor 602 can comprise a partially or fully programmable platform as are known in the art that is configured and arranged (via, for example, corresponding programming) to establish the aforementioned parallel communication session with a server via the wireless interface 601 and to provide the described information to the server via that parallel communication session regarding the mobile device's 600 present location, a target geographic destination, and the desired or required level of acceptable bandwidth to be used when continuing to support a present on-going communication session as the mobile device 600 moves to the target geographic destination.

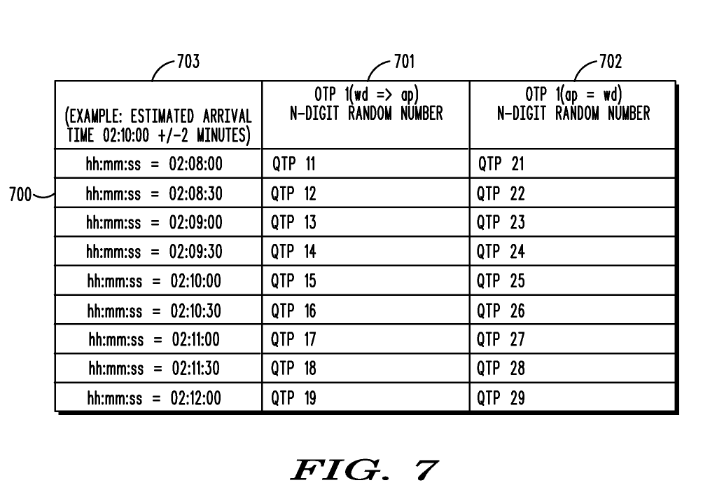

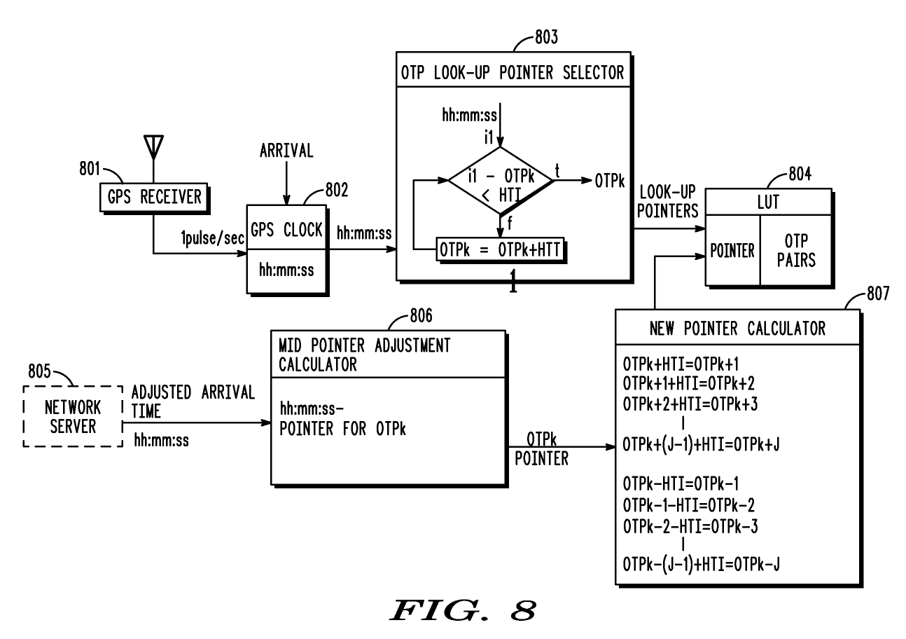

This processor 602 can also be configured and arranged to support or effect the above-described steps, including but not limited to storing received one-time passwords in, for example, a lookup table as comprises a part of a memory 603 that also operably couples to the processor 602. Making momentary reference now to FIG. 7, such a lookup table 700 can comprise a first plurality of one-time passwords (OTP's) 701 and a second plurality of one-time passwords 702. Each can comprise an N-digit random number (where “N” will be understood to comprise an integer value of choice and where “random” will be understood to comprise both truly random as well as pseudo-random sequences as are frequently employed in the art in this regard).

The first plurality of one-time passwords 701 can comprise passwords that the corresponding wireless device (WD) may present to the wireless access point (AP) when seeking to effect a handoff. The second plurality of one-time passwords 702 can comprise passwords that the wireless access point may present to that wireless device when the latter seeking to effect a handoff. (Those skilled in the art will recognize and understand that the particular number of one-time passwords shown in this example serve an illustrative purpose only, and that these teachings will readily accommodate a fewer, or greater, number of such passwords in a given application setting).

In this illustrative example, each pair of one-time passwords correlates to a pointer 703 that itself relates to a given service (comprising, in this example, an arrival time and it's corresponding handoff time interval). Again for the purpose of illustration and not by way of limitation, the arrival times are denoted in hour/minute/second format and can reflect, for example, an actual time of day as corresponds to the application setting. Knowledge of the actual time of day at a given mobile device, wireless access point, and/or server can, in turn, be gleaned in any of a variety of ways. By one approach, for example, such information can be gained through reception of global positioning system (GPS) satellite transmissions.

Returning again to FIG. 6, this processor 602 can be further configured and arranged to accomplish, as desired, any of the other above described actions and responses as regards to, for example, providing location updates during the course of the journey, receiving recommended paths from the server, and/or receiving instructions regarding the scheduled use of multiple wireless access points in parallel with one another to attain the given level of desired/required quality of service.

Those skilled in the art will recognize and understand that such an apparatus 600 may be comprised of a plurality of physically distinct elements as is suggested by the illustration shown in FIG. 6. It is also possible, however, to view this illustration as comprising a logical view, in which case one or more of these elements can be enabled and realized via a shared platform. It will also be understood that such a shared platform may comprise a wholly or at least partially programmable platform as are known in the art.

Referring now to FIG. 8, and for the sake of presenting a more specific, non-limiting example, a mobile device and/or wireless access point as might comport with these teachings will be presented. In this illustrative example, a global positioning system receiver 801 receives corresponding transmissions and extracts included time information to pulse, once per second, a twenty-four hour clock 802 to provide the exact current time in hour/minute/second (hh:mm:ss) format in response to an arrival event. A one-time password lookup pointer selector 803 then uses this arrival time information to provide a corresponding lookup pointer. As shown, a sequential search approach can be employed to select a particular pointer. Other search methods can be employed as well, if desired, such as a binary search approach.

If desired, this selection of a given pointer can comprise, in part, modifying the arrival time information to comprise a value that terminates in either “00” (when the arrival time seconds value are less than “30”) or “30” (when the arrival time seconds value are equal to or great than “30”). By this approach, for example, an arrival time value of “12:34:05” would be converted to “12:34:00” while an arrival time value of “12:34:45” would be converted to “12:34:30.” The resultant pointer is then transferred to and used with a lookup table (LUT) 804 (such as, but not limited to, the illustrative example described above) to thereby identify a corresponding pair of one-time password values as suggested above. The identified one-time passwords can then be employed as described herein to permit the preauthorized status of the mobile device to hasten the handoff process.

As noted above, the path and/or arrival times as were previously considered and scheduled can vary from the previously developed plan and schedule. In such a case, the corresponding network server 805 can transmit updated adjusted arrival times. By one approach, this can comprise transmitting the actual adjusted arrival time using, for example, an hour/minutes/seconds format. By another format, this can comprise transmitting a +/−correction/adjustment value that is to be applied to a previously supplied scheduled arrival time(s).

A mid-point adjustment calculator 806 receives this adjustment information and modifies the arrival time information to a value (or values) that again terminates, in this illustrative example, in “00” seconds or “30” seconds. This resultant value serves to replace a middle pointer in an array of pointers 1 to N (where “N” will again be understood to comprise an integer greater than one). In this example, this comprises selecting a pointer as correlates to one-time password “k” (where “k” will be understood to comprise an integer value).

A new pointer calculator 807 then uses this information to calculate a remaining set of pointer values as may be required. As shown, this can comprise adding the relevant handoff time interval to the selected pointer value OTPk to derive a new updated pointer value OTPk+1. This can comprise, by way of illustration and not by limitation, adding thirty seconds to the previous pointer value (and/or by subtracting thirty seconds from the following pointer value).

These new pointer values are then transferred to the previously described lookup table 804 to replace at least some (and sometimes all) of the previously supplied pointer values. So configured, the previously supplied one-time passwords remain valid and available for use, albeit with an updated set of pointers. This can aid with avoiding the need to transmit a new set of one-time passwords when accommodating a mobile device that experiences variations in its travel schedule.

So configured, a wireless access point and a mobile device are able to readily support and effect a handoff event of an ongoing communication session in a rapid manner as the described passwords can be quickly recovered and transmitted in far less time than authentication and authorization might otherwise be achieved. Those skilled in the art will appreciate, however, that this considerable reduction in delay is achieved with little or no comprise with respect to security. The one-time use nature of the passwords, coupled with their limited and scheduled window of usage, goes far to reduce security concerns to a minimum.

These teachings are highly flexible and can be used in combination with a wide range of communications systems and approaches. These teachings can even be readily applied in conjunction with a system-agile mobile device that is capable of operating compatibly with a number of different systems (and hence different kinds of wireless access points). Those skilled in the art will recognize and appreciate as well that these teachings are readily scalable and can be employed with a relatively few or large number of wireless access points, mobile devices, servers, and so forth. So configured, these teachings provide for a significant degree of assurance that a given on-going communication session will not be unduly interrupted due to movement of the mobile device through a variety of service areas as correspond to a multitude of wireless access points.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at a server and while participating in a communication session with a particular mobile device:
determining that the particular mobile device has present and future needs for a given amount of bandwidth in service of a given communication session while moving with respect to a plurality of wireless access points to a particular geographic destination;
determining a path by which the particular mobile device will likely move to the particular geographic destination;
determining service times during which the particular mobile device will likely receive service with respect to the communication session at various ones of the plurality of wireless access points;
providing a plurality of one-time passwords;
using the path and the service times to schedule support, by at least some of the plurality of wireless access points, for the given communication session while providing at least the given amount of bandwidth, wherein scheduling the support comprises, at least in part, scheduling at least one handoff of the given communication session between at least two of the plurality of wireless access points for the given communication session while providing at least the given amount of bandwidth;
pre-provisioning at least one of the plurality of one-time passwords to a given one of the at least two of the wireless access points prior to the handoff to thereby facilitate rapid authentication of the particular mobile device with respect to later effecting the handoff, wherein the one-time password has a corresponding effective time interval associated therewith;
such that the given communication session remains fully and substantially continuously serviced by various ones of the plurality of wireless access points with at least the given amount of bandwidth as the particular mobile device moves to the particular geographic destination.

2. The method of claim 1 wherein determining service times comprises, at least in part, determining approximate arrival times with which a handoff of the communication session can be coordinated.

3. The method of claim 1 wherein determining service times comprises, at least in part, determining a plurality of approximate predicted arrival times as correspond to when the communication session can be handed off to a given one of the wireless access points.

4. The method of claim 3 wherein automatically determining service times further comprises determining predicted arrival times that each have a corresponding handoff time interval associated therewith, such that an arrival of the particular mobile device within a given handoff time interval equates with arriving at the corresponding predicted arrival time.

5. The method of claim 4 wherein the handoff time interval is substantially identical for each of the predicted arrival times.

6. The method of claim 3 wherein providing a plurality of one-time passwords comprises providing a different one-time password for each of the plurality of approximate predicted arrival times.

7. The method of claim 6 wherein providing a different one-time password for each of the plurality of approximate predicted arrival times comprises providing:
a first different one-time password for each of the plurality of approximate predicted arrival times for use by a wireless access point to authenticate the particular mobile device; and
a second different one-time password for each of the plurality of approximate predicted arrival times for use by the particular mobile device to authenticate the wireless access point.

8. The method of claim 7 wherein pre-provisioning the at least one of the plurality of one-time passwords to a given one of the at least two of the wireless access points comprises, at least in part, further pre-provisioning the second different one-time password to the particular mobile device.

9. The method of claim 1 further comprising:
detecting that the particular mobile device has at least substantially deviated from the path;
determining a new path by which the particular mobile device will likely move to the particular geographic destination;
determining new service times during which the particular mobile device will likely receive service with respect to the communication session at various ones of the plurality of wireless access points;
using the new path and the new service times to update the scheduled support to provide an updated support plan;
pre-provisioning at least one of the plurality of one-time passwords to at least one of the wireless access points to thereby facilitate rapid authentication of the particular mobile device with respect to later effecting a handoff in accordance with the updated support plan.

10. A method comprising:
in a wireless mobile platform engaged in a communication session;
establishing a parallel communication session with a server;
providing information to the server via the parallel communication session regarding, at least in part:
a present geographic location of the wireless mobile platform;
a target geographic destination;
a level of acceptable bandwidth to be used when continuing to support the communication session as the wireless mobile platform moves to the target geographic destination;
receiving from the server via the parallel communication session at least one one-time password to be potentially eventually used when effecting a handoff of the communication session to a corresponding wireless access point while moving towards the target geographic destination to thereby facilitate pre-authenticating the wireless mobile platform with respect to effecting the handoff.

11. The method of claim 10 wherein receiving from the server via the parallel communication session at least one one-time password comprises receiving from the server via the parallel communication session a plurality of one-time passwords to be potentially used when effecting the handoff with the corresponding wireless access point.

12. The method of claim 11 wherein receiving from the server via the parallel communication session at least one one-time password further comprises receiving a corresponding arrival time at which the one-time password can be legitimately utilized to effect the handoff.

13. The method of claim 12 wherein the one-time password has a corresponding handoff time interval during which the one-time password can be legitimately utilized to effect the handoff and outside of which the one-time password cannot be legitimately utilized to effect the handoff.

14. The method of claim 12 further comprising:
storing the at least one one-time password in a lookup table to thereby render the one-time password quickly available at such time as the one-time password may be required to facilitate the handoff.

15. The method of claim 14 wherein storing the at least one one-time password in a lookup table further comprises storing the at least one one-time password in a lookup table using a pointer that corresponds to the corresponding arrival time.

16. The method of claim 15 further comprising modifying at least one pointer to correspond to a different one-time password as a function of changes to the wireless mobile platform's movement to the target geographic destination.

17. A method comprising:
at a wireless access point:
receiving from a server scheduling information regarding a time frame during which an existing communication session for a particular mobile device is to be further supported by the wireless access point with at least a minimal level of predetermined bandwidth support
receiving from the server, prior to a present need to accept a handoff of the communication session for the particular mobile device, at least one one-time password and a corresponding estimated arrival time as correspond to the particular mobile device, which one-time password corresponds to a pre-authorization to accept the handoff of the communication session for the particular mobile device provided the handoff is initiated only during a predetermined handoff time interval as corresponds to the one-time password.

18. The method of claim 17 wherein the at least one one-time password comprises a password that the particular mobile device is expected to present in conjunction with the arrival time in order to receive a benefit of the pre-authorization.

19. The method of claim 17 wherein the at least one one-time password comprises a password that the wireless access point is expected to present to the particular mobile device in conjunction with facilitating the handoff.

20. The method of claim 17 further comprising:
storing the at least one one-time password in a lookup table using a pointer that corresponds to the corresponding arrival time to thereby render the one-time password quickly available at such time as the one-time password may be required to facilitate the handoff;
modifying the pointer as a function of changes to the wireless mobile device's estimated arrival time.
